(19) United States
(12) Patent Application Publication
(10) Pub. No.: US 2019/0299289 A1
(43) Pub. Date: Oct. 3, 2019

(54) Additive Manufacturing Device

(71) Applicant: Hitachi, Ltd., Chiyoda-ku, Tokyo (JP)

(72) Inventor: Kinya AOTA, Tokyo (JP)

(21) Appl. No.: 16/301,478

(22) PCT Filed: Mar. 8, 2017
(86) PCT No.: PCT/JP2017/009123

§ 371 Date: Nov. 14, 2018

(30) Foreign Application Priority Data
May 31, 2016 (JP) 2016-109162

(51) Int. Cl. B22F 3/105; B22F 3/10

(52) U.S. Cl. CPC B22F 3/1055; B33Y 30/00; B22F 3/101

(57) ABSTRACT

The purpose of the present invention is to obtain an additive manufacturing device capable of manufacturing while reducing the flow rate of Ar gas. This additive manufacturing device is characterized in that a reduced-pressure atmosphere is maintained in a manufacturing area, an inert gas is supplied to the manufacturing area, the proportion of gaseous impurities in the manufacturing area is detected, and in case where the proportion of gaseous impurities exceeds a threshold value, the supply of inert gas is reduced.

### TECHNICAL FIELD

The present invention relates to an additive manufacturing device for manufacturing a three-dimensional manufactured object by melting powder with a beam.

### BACKGROUND ART

An additive manufacturing device for performing three-dimensional manufacturing by repeating a process of spreading powder in a manufacturing area, scanning the powder in a predetermined area with a beam, melting and solidifying the powder, lowering the manufacturing area, and spreading powder in the manufacturing area again has been known.

For melting and solidification of metal powder, the additive manufacturing device using high density energy of a laser or an electronic beam and heating the powder to a melting point or higher to melt and solidify the powder has been known.

Generally, when an oxygen content in a manufacturing atmosphere is increased, an oxygen content of a manufactured object is also increased and toughness of the manufactured object is decreased. In order to prevent this problem, PTL 1 discloses an additive manufacturing device having an oximeter disposed in a manufacturing chamber with an Ar atmosphere and increasing a flow rate of Ar when an oxygen concentration is high. As a result, the oxygen content in the Ar atmosphere can be reduced.

### CITATION LIST

### Patent Literature

PTL 1: JP 2009-078558 A

### SUMMARY OF INVENTION

### Technical Problem

However, since gaseous impurity components such as moisture and dirt adhering to a surface of the powder during the manufacturing are generated during the melting of the powder, in the above-mentioned additive manufacturing device, the Ar gas needs to continuously flow. It takes a long manufacturing time to perform the additive manufacturing, so a large amount of Ar gas is required. Therefore, there is a problem in that cost is increased. In addition, a small amount of impurities such as oxygen is contained even in the Ar gas. Therefore, there is a problem in that the higher the purity of the Ar gas used, the higher the cost of the Ar gas.

Considering the above-mentioned circumstances, an object of the present invention is to provide an additive manufacturing device capable of manufacturing while reducing a flow rate of Ar gas.

### Solution to Problem

To achieve the above object, according to the present invention, there is provided an additive manufacturing device for manufacturing a three-dimensional object by spreading powder, forming a solidified layer by scanning the powder with a beam to melt the powder, and adding the solidified layer, the additive manufacturing device including: a reduced-pressure means which makes a manufacturing area into a reduced-pressure atmosphere; an inert gas supply means which supplies an inert gas to the manufacturing area; a detection means which detects a proportion of gaseous impurities in the manufacturing area; and a control means which controls the inert gas supply means to reduce a supply of the inert gas in a case where the proportion of the gaseous impurities detected by the detection means exceeds a threshold value.

### Advantageous Effects of Invention

According to the present invention, it is possible to provide the additive manufacturing device capable of manufacturing the high-purity manufactured object at low cost by reducing the consumption of Ar gas. Further features relating to the present invention will become apparent from the description of this specification and the accompanying drawings. In addition, problems, configurations, and effects other than those described above will be apparent from the description of the following embodiments.

### BRIEF DESCRIPTION OF DRAWINGS

FIG. 1 is a perspective view of a first embodiment.

FIG. 2 is a graph showing a relationship between a proportion of gaseous impurities and a flow rate of Ar gas in the first embodiment.

FIG. 3 is a graph showing a relationship between a proportion of gaseous impurities and a flow rate of Ar gas in a second embodiment.

FIG. 4 is a graph showing a relationship between a flow rate control of Ar gas and an elapsed time in the second embodiment.

### DESCRIPTION OF EMBODIMENTS

Hereinafter, embodiments of the present invention will be described with reference to the drawings.

### First Embodiment

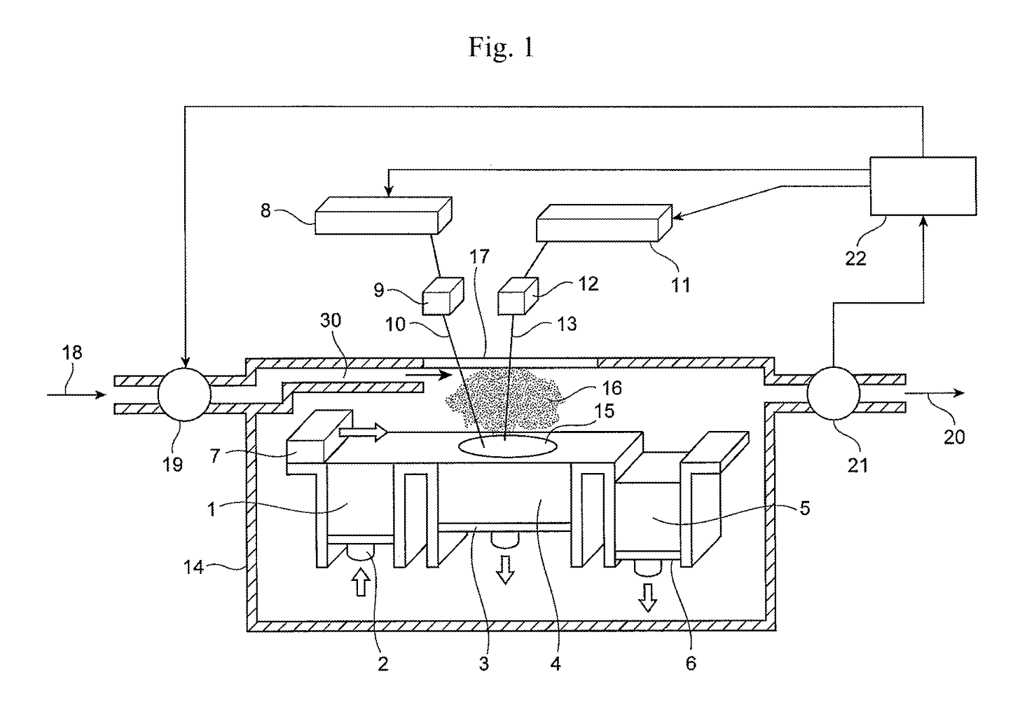

FIG. 1 is a perspective view of a first embodiment. An additive manufacturing device includes a powder supply portion 1, a manufacturing portion 4, and a powder discharge portion 5. The powder supply portion 1, the manufacturing portion 4, and the powder discharge portion 5 are arranged in a line in a horizontal direction in this order, and a coater 7 is provided to reciprocate thereon in a column direction.

Metal powder is supplied to the powder supply portion 1. The powder is pushed upward by lifting up a stage 2. The powder is supplied to an upper surface of the manufacturing portion 4 by moving from the powder supply portion 1 toward the manufacturing portion 4 by the coater 7. The coater 7 further moves and discharges the remaining powder to the powder discharge portion 5. After the discharge, a stage 6 is lowered, and an upper surface of the powder discharge portion 5 is lowered. Thereafter, the coater 7 returns to the powder supply portion 1.

The manufacturing portion 4 performs additive manufacturing by a laser beam. The first embodiment shows the additive manufacturing using two laser beams. A laser beam 10 oscillated from a laser oscillator 8 melts powder on the surface of the manufacturing portion 4 by being scanned by a scanner 9 to forma layered melting and solidifying portion (solidified layer) 15. Similarly, even a laser beam 13 oscillated from a laser oscillator 11 melts powder using a scanner 12 to form the melting and solidifying portion 15. Thereafter, a stage 3 of the manufacturing portion 4 is lowered. By repeating this process, the melting and solidifying portion 15 is three-dimensionally added to form a manufactured object.

The additive manufacturing device includes a reduced-pressure chamber 14 as a reduced-pressure means which makes an atmosphere of a manufacturing area including the manufacturing portion 4 into a reduced-pressure atmosphere. In the first embodiment, the powder supply portion 1, the manufacturing portion 4, and the powder discharge portion 5 are disposed in the reduced-pressure chamber 14. An inside of the reduced-pressure chamber 14 is decompressed by a vacuum pump 20.

The reduced-pressure chamber 14 is provided with a protective glass 17 through which the laser beams 10 and 13 can pass. The protective glass is disposed between the scanner 9 and the manufacturing portion 4. The inside of the reduced-pressure chamber 14 is provided with a nozzle 30 so that an inert gas such as Ar gas can be supplied into the reduced-pressure chamber 14 (inert gas supply means). Since the additive manufacturing device can perform vacuum manufacturing in which the manufactured object is manufactured in the reduced-pressure atmosphere, a gaseous impurity concentration in the manufacturing atmosphere can be lowered.

Compared to the existing manufacturing in the Ar gas atmosphere, the additive manufacturing device can reduce the amount of Ar gas used by the vacuum manufacturing, thereby reducing the cost of Ar gas. Examples of the gaseous impurities may include oxygen, nitrogen, hydrogen, water vapor, carbon monoxide, and the like. In particular, since oxygen, water vapor, and nitrogen react with the molten powder and are mixed into the manufactured object as impurities, mechanical properties of the manufactured object may deteriorate. Therefore, it is necessary to remove the gaseous impurities in the manufacturing atmosphere. These gaseous impurities are generated by heating and melting powder due to dirt and moisture adhering to the surface of the powder. The generated gaseous impurities are removed by the vacuum pump 20.

However, in the manufacturing in the reduced-pressure atmosphere, fumes 16 are generated due to the melting of metal powder during the manufacturing. Since the evaporated metal stays in the reduced-pressure atmosphere, the fumes 16 are solidified from a liquid due to the drop in temperature to become the metal powder. The fumes 16 are a solid, and therefore are not discharged by the vacuum pump 20. If the fumes 16 adhere to and are deposited on an inner surface of the protective glass 17, the laser beam 10 and the laser beam 13 are absorbed by the adhering fumes 16, and the power of the laser beams 10 and 13 reaching the melting and solidifying portion 15 is decreased, which causes a manufacturing defect. In particular, when powder is melted using the two laser beams 10 and 13, the amount of fumes 16 generated is also doubled, so it is necessary to positively remove the melted powder. Since the protective glass 17 is used for the vacuum chamber 14, the present invention is particularly effective for the laser manufacturing.

For removing the fumes 16, it is effective to flow the inert gas during the manufacturing. As the inert gas, Ar gas or He gas is used. However, if the amount of inert gas used is excessively increased, the pressure of the reduced-pressure atmosphere is increased, so the ability of the vacuum pump 20 to remove the gaseous impurities is decreased. Therefore, it is preferable to minimize the flow rate of the inert gas.

Further, it is preferable that the nozzle 30 through which the inert gas flows is as close as possible to the protective glass 17 at a position where the laser beam 10 and the laser beam 13 do not interfere with each other. In the first embodiment, a discharge direction and a position of the nozzle 30 are set so that the inert gas discharged from the nozzle 30 is sprayed toward a glass surface of the protective glass 17. The inert gas blows away the fumes 16 drifting around the protective glass 17, so the fumes 16 can be prevented from adhering to the protective glass 17.

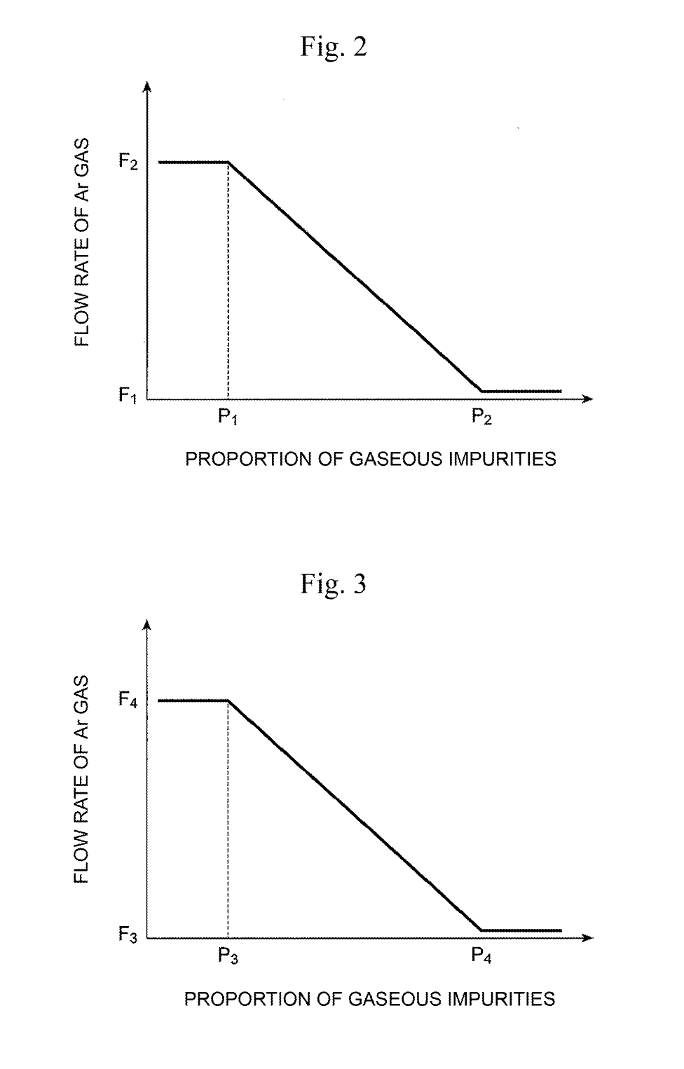

FIG. 2 is a graph showing a relationship between a proportion of the flow rate of Ar gas and the gaseous impurity in the first embodiment. When the proportion of the gaseous impurity in the reduced-pressure chamber 14 is equal to or less than P1 (threshold value), the flow rate of Ar gas is set to be F2 and a large amount of Ar gas is allowed to flow, thereby preferentially removing the fumes 16. When the proportion of the gaseous impurity exceeds P1 (threshold value), a flow meter (inert gas supply means) 19 is controlled to reduce the supply of inert gas.

In the first embodiment, as the proportion of the gaseous impurities is increased from P1 to P2, the flow rate of Ar gas is gradually decreased from F2 to F1, and the gaseous impurities are preferentially removed by the vacuum pump 20. When the proportion of the gaseous impurities is equal to or more than P2, the flow rate of Ar gas is minimized by being adjusted to F1, thereby preferentially removing the gaseous impurities. The proportion of the gaseous impurities is measured by an impurity analyzer 21 provided on the vacuum discharge side shown in FIG. 1. The impurity analyzer 21 constitutes a detection means which detects the proportion of the gaseous impurities in the manufacturing area. The measurement result of the impurity analyzer 21 is input to a flow rate control device 22.

The flow rate control device 22 calculates the flow rate of Ar gas flowing from the flow meter 19 based on the proportion of the gaseous impurities measured by the impurity analyzer 21 and outputs the calculated flow rate of Ar gas as a flow rate control signal to the flow meter 19. The flow meter 19 constitutes an inert gas supply means which supplies an inert gas to the manufacturing area, and makes Ar gas as the inert gas flow by a predetermined flow rate based on the flow rate control signal from the flow rate control device 22. Although the flow rate control device 22 preferentially controls the reduction in the gaseous impurities, when the amount of gaseous impurities generated is increased and the proportion of the gaseous impurities exceeds a preset upper limit (a value larger than P2), the state in which the flow rate of Ar gas is decreased continues for a long time, so a control to temporarily stop the manufacturing may be performed.

According to the first embodiment, the amount of Ar gas used can be decreased by the manufacturing in the reduced-pressure atmosphere, thereby manufacturing the high-purity manufactured object. Furthermore, the adhesion of the fumes 16 to the protective glass 17 can also be prevented, and the manufacturing defect due to the reduction in power of the laser beams 10 and 13 reaching the melting and solidifying portion 15 can be prevented.

### Second Embodiment

FIG. 3 is a graph showing a relationship between a proportion of a flow rate of Ar and gaseous impurities in a second embodiment. The concept of the flow rate control of the Ar gas is the same as that of the first embodiment, but the second embodiment is different from the first embodiment in that the Ar gas flows only when a coater 7 spreads powder.

As shown in FIG. 3, when a proportion of the gaseous impurities is equal to or less than P3, the flow rate of Ar gas is set to be F4 and a large amount of Ar gas is allowed to flow. If the proportion of the gaseous impurities is increased from P3 to P4, the flow rate of Ar gas is reduced from F4 to F3 in inverse proportion thereto. When the proportion of the gaseous impurities is P4 or more, the flow rate of Ar gas is set to be F3. Since the Ar gas does not flow only from immediately after melting of powder to spreading powder, the flow rate of Ar gas can be increased as compared with the first embodiment. The flow rate is increased from F4 to F2.

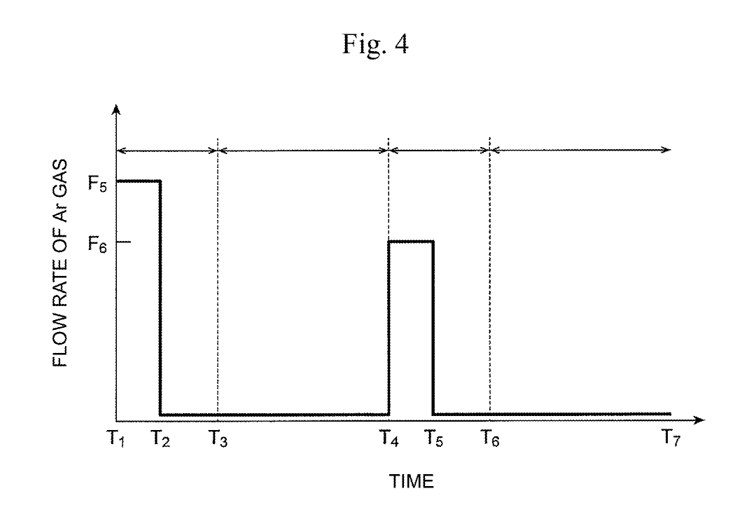

FIG. 4 is a graph showing a relationship between a flow rate control of Ar gas and an elapsed time in the second embodiment. Powder is spread by the coater 7 between time T1 and time T3, and is melted by a laser beam 10 and a laser beam 13 between time T3 and time T4. Thereafter, powder is again spread between time T4 and time T6, and a process of melting powder between time T6 and time T7 is repeated.

On the other hand, the Ar gas having a flow rate F5 of Ar gas flows between T1 and T2 which is time from immediately after the melting of powder to starting the spreading of powder by the coater 7. In addition, the Ar gas having a flow rate F6 of Ar gas flows between T4 and T5 which is time from immediately after the melting of powder to starting the spreading of powder by the coater 7. The values of the flow rates F5 and F6 of Ar gas are determined from the graph of FIG. 3. A large amount of fumes 16 is generated at time T1 and time T4 immediately after the melting of powder. Therefore, a large amount of Ar gas flows between time T1 and time T2 immediately after the melting of powder and between time T4 and time T5, so the fumes 16 can be more efficiently removed than in the first embodiment.

Although the embodiments of the present invention have been described above in detail, the present invention is not limited to the above-described embodiments, and various design changes can be made without departing from the spirit of the present invention described in the claims. For example, the above-described embodiments have been described in detail in order to explain the present invention in an easy-to-understand manner, and are not necessarily limited to those having all the configurations described. Further, a part of the configuration of one embodiment can be replaced by the configuration of another embodiment, and the configuration of one embodiment can also be added to the configuration of another embodiment. In addition, it is possible to add, delete, and replace other configurations with respect to a part of the configuration of each embodiment.

### REFERENCE SIGNS LIST

1 powder supply portion
2 stage
3 stage
4 manufacturing portion
5 powder discharge portion
6 stage
7 coater
8 laser oscillator
9 scanner
10 laser beam
11 laser oscillator
12 scanner
13 laser beam
14 reduced-pressure chamber
15 melting and solidifying portion
16 fumes
17 protective glass
18 Ar gas
19 flow meter
20 vacuum pump
21 impurity analyzer
22 flow control device

1. An additive manufacturing device for manufacturing a three-dimensional object by spreading powder, forming a solidified layer by scanning the powder with a beam to melt the powder, and adding the solidified layer, the additive manufacturing device comprising:
a reduced-pressure means which makes a manufacturing area into a reduced-pressure atmosphere;
an inert gas supply means which supplies an inert gas to the manufacturing area;
a detection means which detects a proportion of gaseous impurities in the manufacturing area; and
a control means which controls the inert gas supply means to reduce a supply of the inert gas in a case where the proportion of the gaseous impurities detected by the detection means exceeds a threshold value.

2. The additive manufacturing device according to claim 1, wherein the control means reduces the supply of inert gas as the proportion of the gaseous impurities is increased.

3. The additive manufacturing device according to claim 2, wherein the inert gas is Ar gas or He gas.

4. The additive manufacturing device according to claim 3, wherein the gaseous impurities are at least one of oxygen, nitrogen, hydrogen, moisture, and carbon monoxide.

5. The manufacturing device according to claim 4, wherein the beam is a laser beam.

6. The additive manufacturing device according to claim 5, wherein the inert gas supply means makes the inert gas flow immediately after the melting of the powder.

7. The additive manufacturing device according to claim 6, wherein a protective glass through which the laser beam is able to pass is provided between a laser oscillator for oscillating the laser beam and the manufacturing area, and
the inert gas supply means sprays the inert gas toward a glass surface of the protective glass.

8. The additive manufacturing device according to claim 7, wherein when the proportion of the gaseous impurities exceeds an upper limit, the manufacturing of the object is stopped.
